(19) United States
(12) Patent Application Publication
(10) Pub. No.: US 2020/0306125 A1
(43) Pub. Date: Oct. 1, 2020

(54) Massage Machine

(71) Applicant: Fuji Medical Instruments Mfg. Co., Ltd., Osaka (JP)

(72) Inventors: Masaki ONO, Osaka (JP); Masaaki MASUDA, Osaka (JP)

(73) Assignee: Fuji Medical Instruments Mfg. Co., Ltd., Osaka (JP)

(21) Appl. No.: 16/778,625

(22) Filed: Jan. 31, 2020

(30) Foreign Application Priority Data
Mar. 27, 2019 (JP) 2019-059762

(51) Int. Cl. A61H 7/00

(52) U.S. Cl. CPC A61H 7/00; A61H 2201/0149; A61H 2201/025; A61H 2201/0207; A61H 2203/0431

(57) ABSTRACT

A massage machine includes an air outlet for blowing out air, a blower unit for feeding air to the air outlet, and a contact surface provided so as to be contactable with a person to be treated. The air outlet is oriented either rightward or leftward. The air outlet and the contact surface are distanced from each other in a generally normal direction of the contact surface. The contact surface is positioned other than between the air outlet and the person to be treated while the person to be treated and the contact surface are in contact with each other. The air outlet is prevented from overlapping with the person to be treated as viewed in a left-and-right direction while the person to be treated and the contact surface are in contact with each other.

### RELATED APPLICATIONS

This nonprovisional application claims priority under 35 U.S.C. § 119(a) on Patent Application No. 2019-059762 filed in Japan on Mar. 27, 2019, the entire contents of which are hereby incorporated by reference.

### BACKGROUND OF THE INVENTION

### Field of the Invention

The present invention relates to a massage machine.

### Description of the Related Art

In recent years, there have been developed various massage machines capable of enhancing temperature-environment comfortableness around sites of a person to be treated that are in contact with the massage machine.

As an example, a massage machine disclosed in JP 2016-131812 A is equipped with heaters which impart warm temperature to soles of a person to be treated (see paragraph 0116 in JP 2016-131812 A).

As another example, a massage machine disclosed in JP 2016-220711 A is equipped with a heater which imparts warm temperature to the back of a person to be treated (see abstract in JP 2016-220711 A).

As still another example, a massage machine disclosed in JP 2005-102919 A is equipped with heaters which are contained in kneading balls to impart warm temperature to treatment sites of a person to be treated (see paragraphs 0016 to 0019 in JP 2005-102919 A).

As a further example, a massage machine disclosed in JP 2013-66508 A is equipped with a blower unit for blowing air to treatment sites of a person to be treated (see abstract in JP 2013-66508 A).

With an aim of allowing a person to be treated to escape from a massage machine in case of emergency, the massage machine is structured so as not to fully cover the frontage of the person to be treated. That is, while some sites of the person to be treated are in contact with the massage machine, other sites of the person to be treated are left out of contact with the massage machine.

The above-described conventional massage machines, as has been the case heretofore, are indeed capable of enhancing temperature-environment comfortableness around sites of a person to be treated that are in contact with the massage machine, but incapable of enhancing temperature-environment comfortableness around sites of the person to be treated that are out of contact with the massage machine. Therefore, for example, in cases of feeling cold on the front side of thighs of the person to be treated during use of the massage machine, it has been impossible for the person to be treated to dissipate the coldness without taking measures such as using a lap robe.

### SUMMARY OF THE INVENTION

An object of the present invention is to provide a massage machine capable of enhancing temperature-environment comfortableness around sites of a person to be treated that are out of contact with the massage machine.

A massage machine disclosed herein includes: an air outlet for blowing out air; a blower unit for feeding air to the air outlet; and a contact surface provided so as to be contactable with a person to be treated, wherein the air outlet is oriented either rightward or leftward, the air outlet and the contact surface are distanced from each other in a generally normal direction of the contact surface, the contact surface is positioned other than between the air outlet and the person to be treated while the person to be treated and the contact surface are in contact with each other, and the air outlet is prevented from overlapping with the person to be treated as viewed in a left-and-right direction while the person to be treated and the contact surface are in contact with each other.

Meanings and advantageous effects of the present invention will become more apparent from the description of an embodiment given below. However, the following embodiment is given strictly as one embodiment of the invention, and meanings of terms of the invention or individual claim components are in no sense limited to the description of the following embodiment.

### DESCRIPTION OF THE DRAWINGS

FIG. 1 is a schematic perspective view of a massage machine according to one embodiment;

FIG. 2 is a view showing a positional relationship among a base, a frame portion of a backrest part, a blower unit, and heaters;

FIG. 3 is a sectional view of a seat part and a first circulation passage which are cut by a plane perpendicular to a back-and-forth direction, as viewed from the rear side;

FIG. 4 is a sectional view of the seat part and the first circulation passage which are cut by a plane perpendicular to the back-and-forth direction, as viewed from the rear side;

FIG. 5 is a schematic perspective view of a massage machine according to one modification;

FIG. 6 is a sectional view of a seat part and a first circulation passage which are cut by a plane perpendicular to a back-and-forth direction, as viewed from the rear side; and

FIG. 7 is a sectional view of the seat part and the first circulation passage which are cut by a plane perpendicular to the back-and-forth direction, as viewed from the rear side.

### DESCRIPTION OF THE PREFERRED EMBODIMENTS

### 1. Embodiment

Hereinbelow, an exemplary embodiment of the present invention will be described in detail with reference to the accompanying drawings.

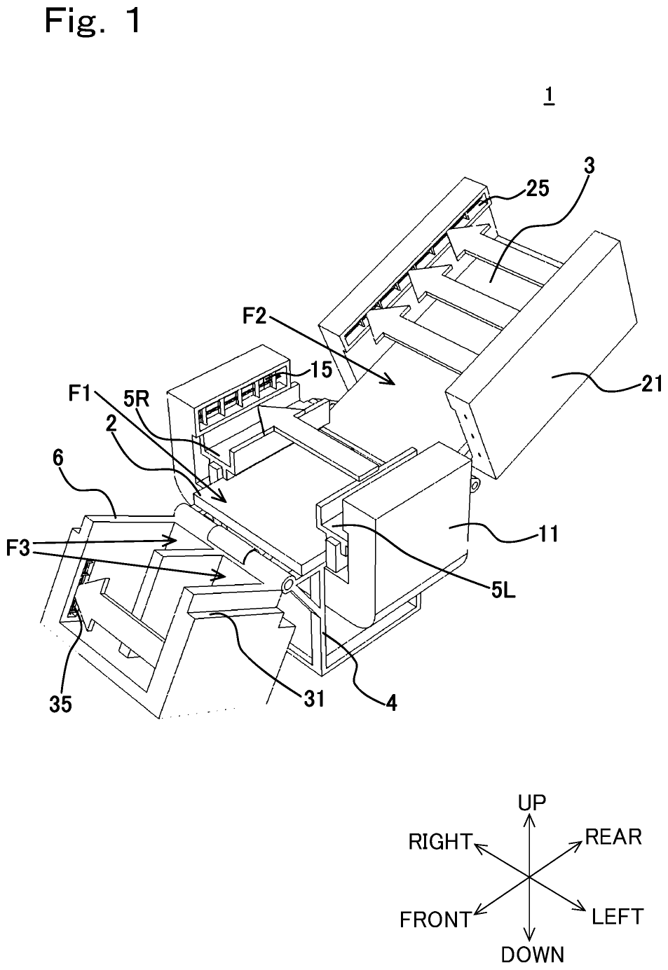

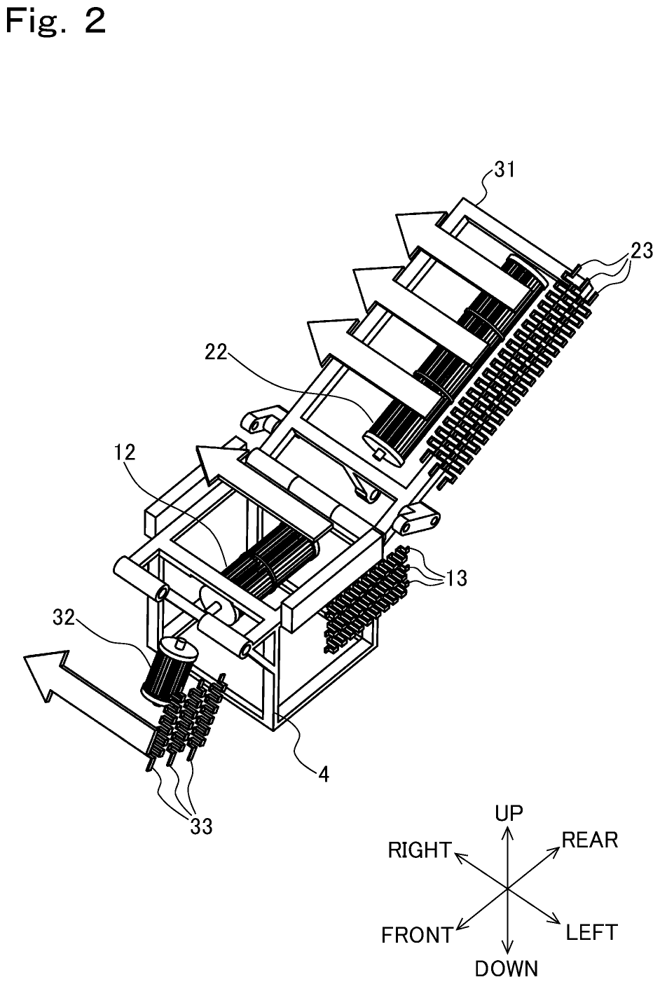

FIG. 1 is a schematic perspective view of a massage machine 1 according to one embodiment (hereinafter, referred to as “massage machine 1”). It is noted that flat-plate arrows in FIG. 1 and later-described FIG. 2 indicate air flows.

Hereinafter, a front side (front-face side) as viewed from a person to be treated seated on the massage machine 1 with a backrest part 3 non-laid down will be referred to as ‘front side,’ and a rear side (back face side) as viewed from the person to be treated seated on the massage machine 1 with its backrest part 3 non-laid down will be referred to as ‘rear side.’ Also, an upper side (head side) as viewed from the person to be treated seated on the massage machine 1 with its backrest part 3 non-laid down will be referred to as ‘upper side,’ and a lower side (leg side) as viewed from the person to be treated seated on the massage machine 1 with its backrest part 3 non-laid down will be referred to as ‘lower side.’ Also, a right side as viewed from the person to be treated seated on the massage machine 1 with its backrest part 3 non-laid down will be referred to as ‘right side,’ and a left side as viewed from the person to be treated seated on the massage machine 1 with its backrest part 3 non-laid down will be referred to as ‘left side.’

The massage machine 1 includes a seat part 2, a backrest part 3, a base 4, a left-and-right pair of armrest parts 5L and 5R, and an ottoman 6.

The seat part 2 supports buttocks and thighs of the person to be treated. The seat part 2 includes a first contact surface F1. That is, the massage machine 1 includes the first contact surface F1. The first contact surface F1 is provided so as to be contactable with the buttocks and thighs of the person to be treated.

The backrest part 3 supports the shoulder, waist and back of the person to be treated. The backrest part 3 includes a second contact surface F2. That is, the massage machine 1 includes the second contact surface F2. The second contact surface F2 is provided so as to be contactable with the shoulder, waist and back of the person to be treated.

The backrest part 3 is mounted at a rear end of the seat part 2 so as to be turnable about a reclining rotational axis extending along a left-and-right direction. On the backrest part 3, a massage unit (not shown) having a treatment member is provided. The massage unit is guided by guide rails (not shown) provided in the backrest part 3 so as to be up/down movable in a longitudinal direction of the backrest part 3. It is noted that the guide rails may be extended up to the rear of the seat part 2 so that the massage unit is movable in the longitudinal direction of the seat part 2 and the backrest part 3. The massage unit includes a treatment member, a kneading drive mechanism for making the treatment member execute kneading motions, and a patting drive mechanism for making the treatment member execute patting motions.

The base 4 supports the seat part 2 and the armrest parts 5L and 5R.

The armrest part 5L is located at an upper left end of the seat part 2, and the armrest part 5R is located at an upper right end of the seat part 2. The armrest parts 5L and 5R have recessed portions that are recessed downward, respectively. The recessed portion of the armrest part 5L accommodates and supports the left forearm portion and left hand of the person to be treated. The recessed portion of the armrest part 5R accommodates and supports the right forearm portion and right hand of the person to be treated.

The ottoman 6 holds the lower legs and feet of the person to be treated. The ottoman 6 includes a third contact surface F3. That is, the massage machine 1 includes the third contact surface F3. The third contact surface F3 is provided so as to be contactable with the calves of the person to be treated.

The ottoman 6 is mounted on the base 4 so as to be turnable about a rotational axis extending in the left-and-right direction.

The massage machine 1 further includes a first circulation passage 11, a second circulation passage 21, and a third circulation passage 31. The first circulation passage 11 is placed so as to surround the right side, lower side and left side of the seat part 2. The second circulation passage 21 is placed so as to surround the right side, rear side and left side of the backrest part 3. The third circulation passage 31 is placed so as to surround the right side, rear side and left side of the ottoman 6.

A first blower unit 12 and a first heater 13 as shown in FIG. 2 are provided inside the first circulation passage 11. A second blower unit 22 and a second heater 23 as shown in FIG. 2 are provided inside the second circulation passage 21. A third blower unit 32 and a third heater 33 as shown in FIG. 2 are provided inside the third circulation passage 31. It is noted that FIG. 2 is a view showing a positional relationship among the base 4, a frame portion 31 of the backrest part 3, the first blower unit 12 and the first heater 13, the second blower unit 22 and the second heater 23, and the third blower unit 32 and the third heater 33.

In this embodiment, cross flow fans are used as the first blower unit 12, the second blower unit 22 and the third blower unit 32, respectively. An axial direction of each cross flow fan is generally perpendicular to the left-and-right direction.

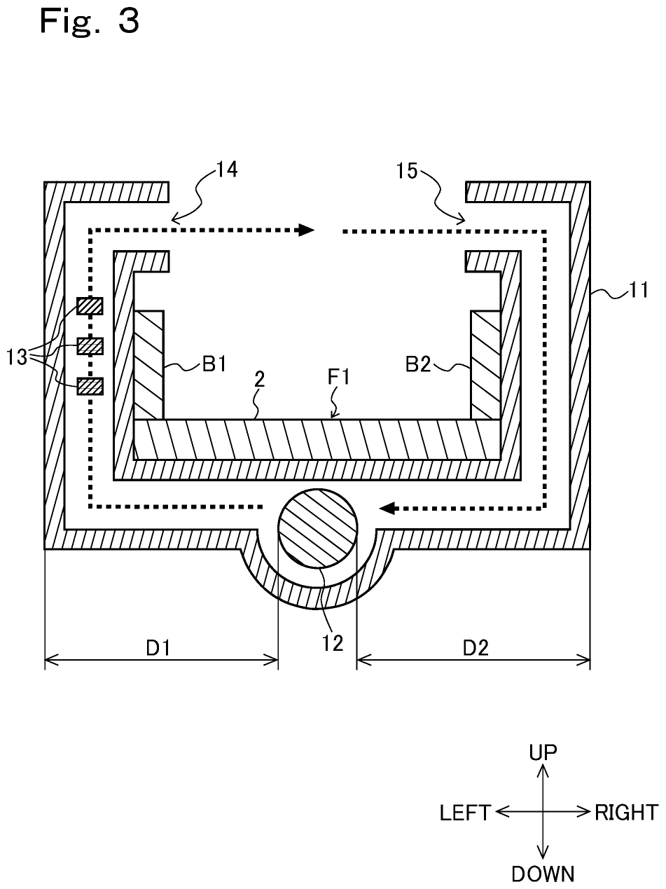

The first blower unit 12 is placed at a center of the massage machine 1 in the left-and-right direction. The first heater 13 is placed between the first blower unit 12 and a first air outlet (not shown in FIG. 1) provided at one end of the first circulation passage 11. Placement of the individual parts associated with the first air outlet (not shown in FIG. 1) will be further described with reference to FIG. 3.

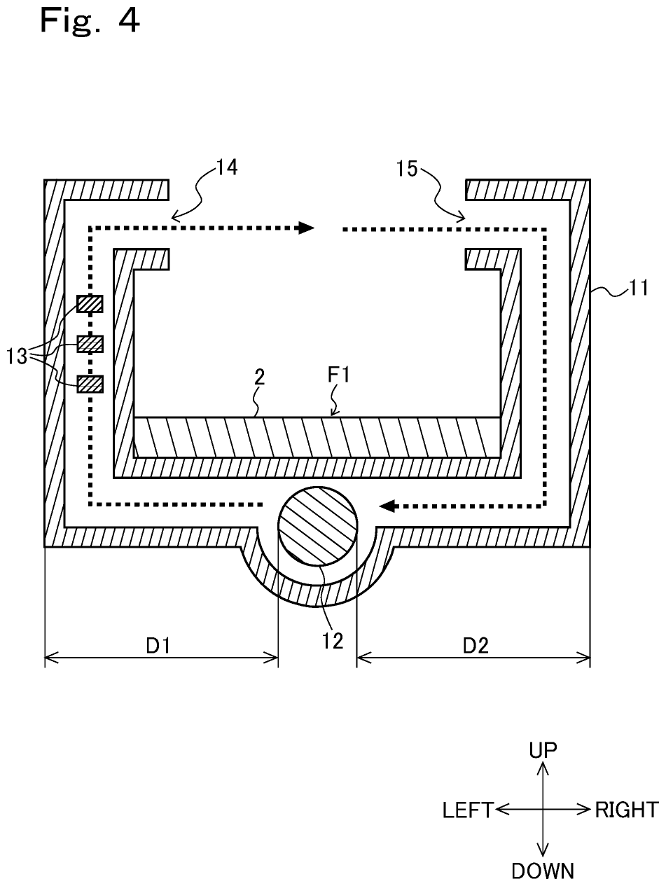

FIG. 3 is a sectional view of the seat part 2 and the first circulation passage 11 that are cut by a plane perpendicular to a back-and-forth direction, as viewed from the rear side. It is noted that broken-line arrows in FIG. 3 indicate air flows. Whereas FIG. 3 is a sectional view in a case where the massage machine 1 includes air bags B1 and B2 for buttock-lateral portions, FIG. 4 shows a sectional view in a case where the massage machine 1 includes no air bags B1 and B2 for buttock-lateral portions.

As described above, the first blower unit 12 is placed at the center of the massage machine 1 in the left-and-right direction. In other words, a distance D1 between a left end of the first blower unit 12 and a left end of the first circulation passage 11 is generally equal to a distance D2 between a right end of the first blower unit 12 and a right end of the first circulation passage 11. Each of the second blower unit 22 and the third blower unit 32 is also placed at a center of the massage machine 1 in the left-and-right direction as in the case of the first blower unit 12 (see FIG. 2). Placing the first blower unit 12, the second blower unit 22 and the third blower unit 32 at left-and-right centers of the massage machine 1, respectively, yields a better weight balance of the massage machine 1 in the left-and-right direction.

A first air outlet 14 is provided at one end of the first circulation passage 11, and a first air inlet 15 is provided at the other end of the first circulation passage 11. The first air outlet 14 is for blowing out air, and the first air inlet 15 is for sucking in air. Desirably, the first air outlet 14 is provided with straightening vanes for straightening air flows.

The first air outlet 14 is oriented rightward, and the first air inlet 15 is oriented leftward. The first air outlet 14 and the first air inlet 15 are opposed to each other. Since the first air outlet 14 and the first air inlet 15 are opposed to each other, the first air inlet 15 is enabled to efficiently suck in air blown out from the first air outlet 14.

The first circulation passage 11 returns air, which has been sucked by the first air inlet 15, to the first air outlet 14. The first blower unit 12 generates an air flow in the first circulation passage 11. Providing the first circulation passage 11 eliminates the need for providing a suction unit for air suction on the first air inlet 15 side independently of the first blower unit 12. Thus, a cost reduction becomes practicable.

While the first contact surface F1 and the buttocks and thighs of the person to be treated are in contact with each other, the first contact surface F1 is positioned between the person to be treated and an intermediate portion of the first circulation passage 11 in a generally normal direction of the first contact surface F1. With such a placement, the intermediate portion of the first circulation passage 11 does not interfere when the person to be treated is seated on the massage machine 1. It is noted that since the first contact surface F1 is not a level plane, a normal direction of an imaginary plane that approximates the first contact surface F1 may be regarded as the generally normal direction of the first contact surface F1.

The first heater 13 is provided between the air flow opening of the first blower unit 12 and the first air outlet 14. As a result of this, air blown out from the first air outlet 14 can be heated with a low loss. Also, since heated air, after sucked by the first air inlet 15, is returned to the first air outlet 14, it becomes possible to reduce electric power that is necessary for the first heater 13 to make the air, which is blown out from the first air outlet 14, reach a desired temperature.

The first air outlet 14 as well as the first air inlet 15 and the first contact surface F1 are distanced from each other in a generally normal direction of the first contact surface F1.

While the first contact surface F1 and the buttocks and thighs of the person to be treated are in contact with each other, the first contact surface F1 is not positioned between the first air outlet 14 or the first air inlet 15 and the thighs of the person to be treated. More specifically, both the first air outlet 14 and the thighs of the person to be treated are positioned above the first contact surface F1. As a result, the front side of the thighs of the person to be treated can be kept warm by air (air curtain) blown out from the first air outlet 14. Further, heating the air (air curtain) blown out from the first air outlet 14 by the first heater 13 makes it possible to warm the front side of the thighs of the person to be treated. That is, it becomes possible to enhance temperature-environment comfortableness around the front side of the thighs of the person to be treated while the massage machine 1 is used under a low-temperature environment. Moreover, since coldness of the person to be treated can be suppressed, it becomes expectable to promote the bloodstream as well as improve the treatment effects.

In this embodiment, the first air outlet 14 and the first air inlet 15 are placed so as not to overlap with the person to be treated, as viewed in the left-and-right direction, while the first contact surface F1 and the buttocks and thighs of the person to be treated are in contact with each other. For example, in a case where the person to be treated is an adult man of standard body type, it is appropriate that the first air outlet 14 and the first air inlet 15 are prevented from overlapping with the person to be treated, as viewed in the left-and-right direction, while the first contact surface F1 and the buttocks and thighs of the person to be treated are in contact with each other. As a result of this, air (air curtain) blown out from the first air outlet 14 is prevented from impinging on the person to be treated, so that the person to be treated is kept free from feelings of uneasiness, uncomfortableness or the like. Furthermore, since the air (air curtain) blown out from the first air outlet 14 is prevented from impinging on the person to be treated, its function as an air curtain is fulfilled to the utmost.

Placement of individual parts associated with a second air outlet (not shown) provided at one end of the second circulation passage 21 as well as placement of individual parts associated with a third air outlet (not shown) provided at one end of the third circulation passage 31 are similar to the placement of individual parts associated with the first air outlet 14 (see FIGS. 3 and 4) provided at one end of the first circulation passage 11.

By virtue of air (air curtain) blown out from the second air outlet (not shown), the face, chest and belly of the person to be treated can be kept warm. Further, heating the air (air curtain) blown out from the second air outlet (not shown) by the second heater 23 makes it possible to warm the face, chest and belly of the person to be treated. Consequently, it becomes possible to enhance temperature-environment comfortableness around the face, chest and belly of the person to be treated while the massage machine 1 is used under a low-temperature environment. Moreover, since coldness of the person to be treated can be suppressed, it becomes expectable to promote the bloodstream as well as improve the treatment effects.

By virtue of air (air curtain) blown out from the third air outlet (not shown), the knees and tiptoes of the person to be treated can be kept warm. Further, heating the air (air curtain) blown out from the third air outlet (not shown) by the third heater 33 makes it possible to warm the knees and tiptoes of the person to be treated. Consequently, it becomes possible to enhance temperature-environment comfortableness around the knees and tiptoes of the person to be treated while the massage machine 1 is used under a low-temperature environment. Moreover, since coldness of the person to be treated can be suppressed, it becomes expectable to promote the bloodstream as well as improve the treatment effects.

### 2. Modification

The embodiment disclosed hereinabove should be construed as not being limitative but being an exemplification at all points. It should be comprehended that the technical scope of the invention is defined not by the above description of the embodiment but by the appended claims, including all changes and modifications equivalent in sense and range to the claims.

For example, unlike the above embodiment, the second air outlet (not shown) and a second air inlet 25 provided at the other end of the second circulation passage 21 may be placed so as not to be positioned above the neck of the person to be treated while the second contact surface F2 and the shoulder, waist and back of the person to be treated are in contact with each other. As a result of this, the person to be treated's feeling hot at the face can be suppressed.

In this embodiment, there exist air (air curtain) blown out from the first air outlet 14, air (air curtain) blown out from the second air outlet (not shown), and air (air curtain) blown out from the third air outlet (not shown). However, the number of air outlets is not limited to three, and may be two or less, or four or more.

As another example, a deodorizer such as activated carbon filter may be provided on the massage machine 1. The deodorizer may be placed, for example, nearby the first air inlet 15, the second air inlet 25 and a third air inlet 35.

As still another example, an aromatic may be provided on the massage machine 1. The aromatic may appropriately be placed, for example, nearby the first air outlet 14, the second air outlet (not shown) and the third air outlet (not shown). Air curtains' carrying aroma makes it possible to form a local aromatic space. As a result of this, the risk that aroma emitted from the aromatic may be mixed with other smells to form an offensive odor can be reduced.

As a further example, a heating device other than heaters may be provided instead of the heaters.

For example, unlike the above embodiment, the configuration may be such that no heating devices are provided. With a configuration in which no heating devices are provided, places around sites of the person to be treated that are out of contact with the massage machine can be kept warm by air curtains as described above.

As an example, unlike the above embodiment, a cooling device may be provided instead of the heating device or in addition to the heating device. Operating the cooling device to cool air (air curtain) blown out from air outlets by the cooling device makes it possible to cool vicinities of sites of the person to be treated that are out of contact with the massage machine. That is, it becomes possible to enhance temperature-environment comfortableness around sites of the person to be treated that are out of contact with the massage machine in cases where the massage machine is used under a high-temperature environment or where the body temperature of the person to be treated just after bathing or the like has been raised.

In the case where both a heating device and a cooling device are provided, since the heating device and the cooling device are unlikely to be simultaneously operated, it is desirable to use a device serving as both a heating device and a cooling device. The device serving as both a heating device and a cooling device may be a Peltier element as an example.

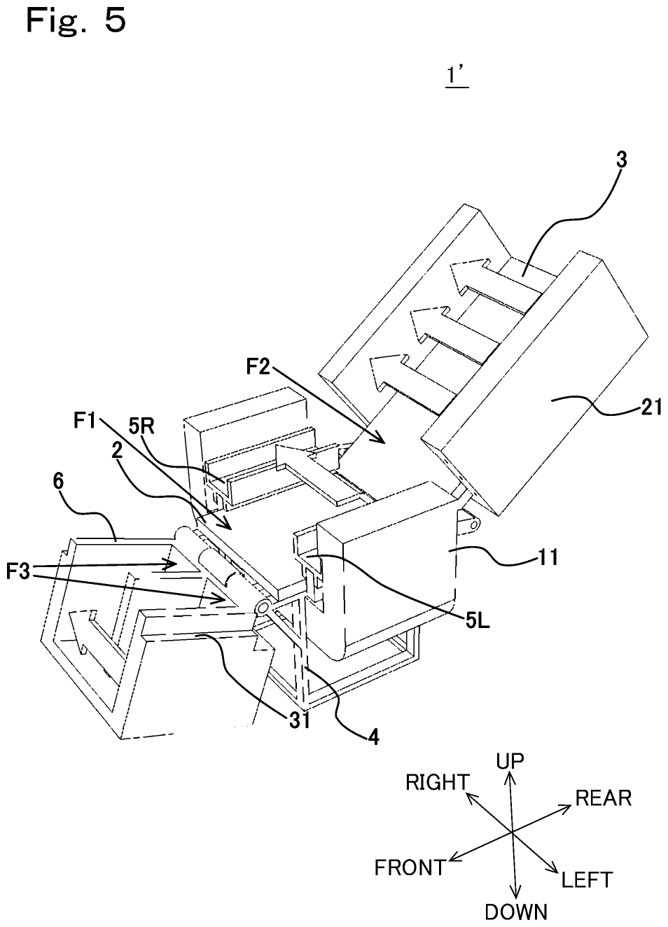

For example, unlike the above embodiment, the configuration may be such that no air inlets opposed to air outlets are provided as in the case of a massage machine 1′ shown in FIG. 5. The massage machine 1′ shown in FIG. 5 is so configured that in the massage machine 1 shown in FIG. 1, the first air inlet 15, the second air inlet 25 and the third air inlet 35 are blocked, while a first opening (not shown) is provided over a passage ranging from the blockage of the first air inlet 15 to the first blower unit 12, a second opening (not shown) is provided over a passage ranging from the blockage of the second air inlet 25 to the second blower unit 22, and an opening (not shown) is provided over a passage ranging from the blockage of the third air inlet 35 to the third blower unit 32. Accordingly, in the massage machine 1′ of FIG. 5, passages 11, 21 and 31 are no longer circulation passages.

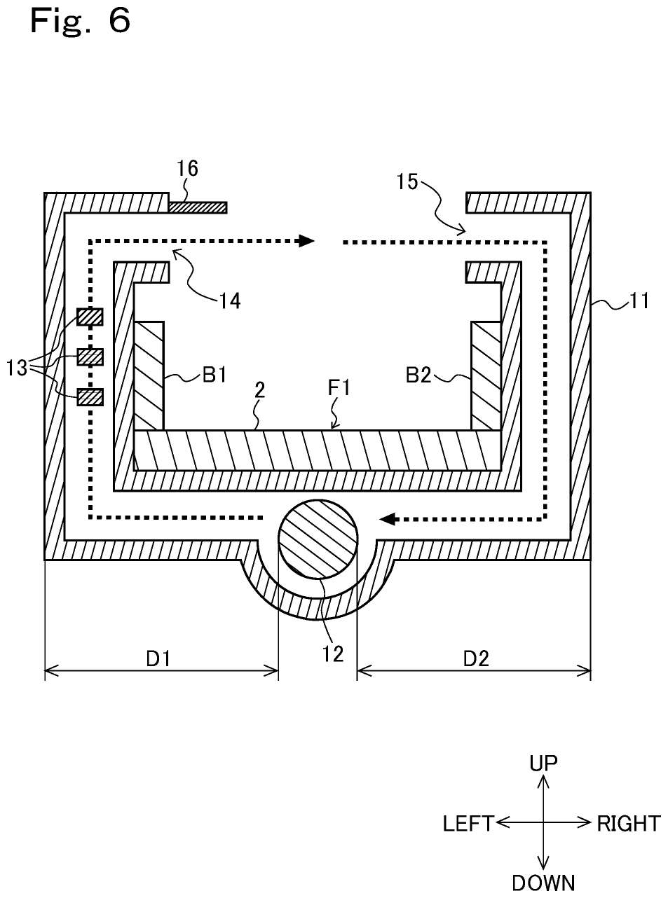

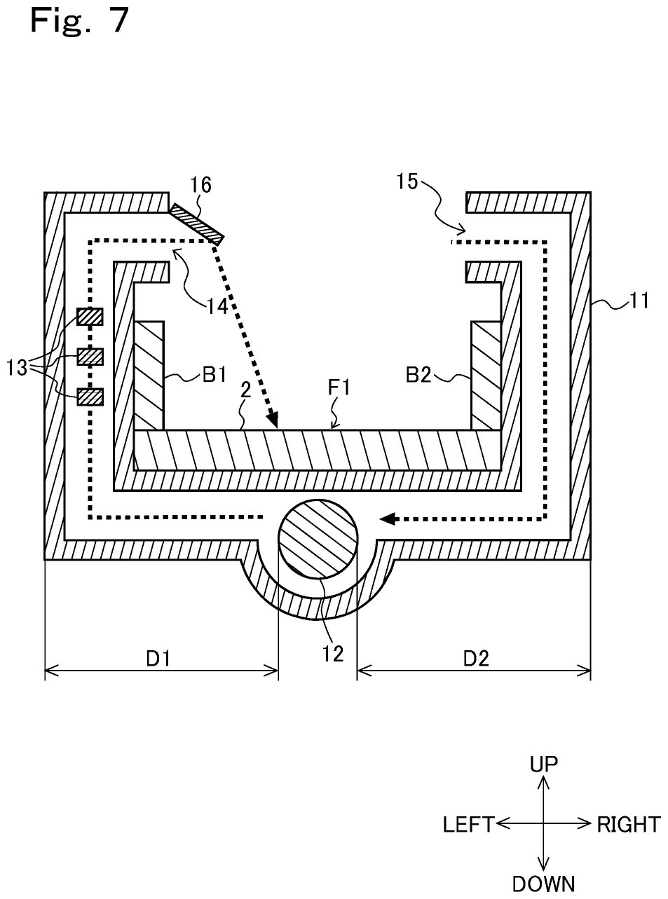

For example, as shown in FIGS. 6 and 7, a wind-direction changing member 16 enabled to change the direction of air blown out from the first air outlet 14 may be provided. The wind-direction changing member 16, as shown in FIG. 7, is enabled to apply air blown out from the first air outlet 14 to the first contact surface F1. In a case where the first contact surface F1 is made from synthetic leather in which a base material is coated with polyurethane resin as an example, the first contact surface F1 would deteriorate progressively due to hydrolyzation. Therefore, applying a wind to the first contact surface F1 to dry the surface makes it possible to suppress the deterioration of the first contact surface F1.

Since the air blown out from the first air outlet 14 cannot be applied to the first contact surface F1 unless the person to be treated is seated on the massage machine 1, the first blower unit 12 is made operable even while the massage machine 1 is out of massage operation. Preferably, for example, the first blower unit 12 is held stopped from operation during a period from an end of a massage operation to an elapsing point of a first specified time; when the first specified time has elapsed since the end of the massage operation, the wind-direction changing member 16 is changed from a state of FIG. 6 to a state of FIG. 7; and the first blower unit 12 is kept operating so as to apply the wind to the first contact surface F1 during a period from the changing point of the wind-direction changing member 16 from the state of FIG. 6 to the state of FIG. 7 until when a second specified time elapses.

### 3. Conclusion

The massage machine described hereinabove, in a configuration thereof (first configuration), includes: an air outlet for blowing out air; a blower unit for feeding air to the air outlet; and a contact surface provided so as to be contactable with a person to be treated, wherein the air outlet is oriented either rightward or leftward, the air outlet and the contact surface are distanced from each other in a generally normal direction of the contact surface, the contact surface is positioned other than between the air outlet and the person to be treated while the person to be treated and the contact surface are in contact with each other, and the air outlet is prevented from overlapping with the person to be treated as viewed in a left-and-right direction while the person to be treated and the contact surface are in contact with each other.

The massage machine of the first configuration may have such a configuration (second configuration) as to further include a temperature-variable unit for varying temperature of air blown out from the air outlet.

The massage machine of the first or second configuration may have such a configuration (third configuration) as to further include an air inlet for sucking in air, wherein the air outlet and the air inlet are opposed to each other.

The massage machine of the third configuration may have such a configuration (fourth configuration) as to further include a circulation passage for returning air sucked in by the air inlet to the air outlet, wherein the blower unit is placed within the circulation passage, and the contact surface is positioned between the person to be treated and part of the circulation passage in a generally normal direction of the contact surface while the person to be treated and the contact surface are in contact with each other.

The massage machine of the fourth configuration may have such a configuration (fifth configuration) that the blower unit is placed at a center of the massage machine in a left-and-right direction.

The massage machine of any one of the first to fifth configurations may have such a configuration (sixth configuration) as to further include a wind-direction changing member provided so as to be changeable in direction of air blown out from the air outlet, wherein air blown out from the air outlet can be applied to the contact surface.

The massage machine of the sixth configuration may have such a configuration (seventh configuration) that the blower unit is provided so as to be operable even while the massage machine is out of massage operation.

What is claimed is:

1. A massage machine comprising:
an air outlet for blowing out air;
a blower unit for feeding air to the air outlet; and
a contact surface provided so as to be contactable with a person to be treated,
wherein
the air outlet is oriented either rightward or leftward,
the air outlet and the contact surface are distanced from each other in a generally normal direction of the contact surface,
the contact surface is positioned other than between the air outlet and the person to be treated while the person to be treated and the contact surface are in contact with each other, and
the air outlet is prevented from overlapping with the person to be treated as viewed in a left-and-right direction while the person to be treated and the contact surface are in contact with each other.

2. The massage machine according to claim 1, further comprising
a temperature-variable unit for varying temperature of air blown out from the air outlet.

3. The massage machine according to claim 1, further comprising
an air inlet for sucking in air,
wherein
the air outlet and the air inlet are opposed to each other.

4. The massage machine according to claim 3, further comprising
a circulation passage for returning air sucked in by the air inlet to the air outlet,
wherein
the blower unit is placed within the circulation passage, and
the contact surface is positioned between the person to be treated and part of the circulation passage in a generally normal direction of the contact surface while the person to be treated and the contact surface are in contact with each other.

5. The massage machine according to claim 4, wherein
the blower unit is placed at a center of the massage machine in a left-and-right direction.

6. The massage machine according to claim 1, further comprising
a wind-direction changing member provided so as to be changeable in direction of air blown out from the air outlet,
wherein
air blown out from the air outlet can be applied to the contact surface.

7. The massage machine according to claim 6, wherein
the blower unit is provided so as to be operable even while the massage machine is out of massage operation.
